(19) United States
(12) Patent Application Publication
(10) Pub. No.: US 2003/0185362 A1
(43) Pub. Date: Oct. 2, 2003

(54) Communication system and communication service method through internet call intermediation

(76) Inventor: Sangkyun Kim, Seoul (KR)

Correspondence Address: Kenneth C. Winterton, Esq., SHERIDAN ROSS P.C., Suite 1200, 1560 Broadway, Denver, CO, 80202-5141, US

(21) Appl. No.: 10/114,814

(22) Filed: Apr. 2, 2002

(51) Int. Cl. H04M 15/00; H04L 12/28; H04L 12/56; H04J 3/16; H04J 3/22

(52) U.S. Cl. 379/120; 370/401; 370/466; 370/467

(57) ABSTRACT

A communication system and a communication service method through Internet call intermediation are disclosed, in which servers call a calling party and a called party using a callback function when a telephone call is requested through the Internet, to allow the calling party and called party to communicate with each other, thereby enabling convenient communication between them with lower charges. The communication system performs telephone communication by a service group constructed of a web server, a network management server, a billing server, a call intermediation server, a DB server, and a gateway. The communication service method includes a communication authentication step in which a calling party judges if a telephone call is available or not; a communication request step in which the calling party inputs his telephone number and a called party's telephone number to request the telephone call; a speaker callback step for callback-dialing the inputted telephone numbers of the calling party and the called party; a telephone call execution step in which the calling party communicates with the called party and charges for the telephone call are charged based on the period of calling time; and a charge billing step for billing the charges for the telephone call upon the completion of the telephone call. Accordingly, users can use domestic and international telephone services with lower charges by using the callback function.

### BACKGROUND OF THE INVENTION

1. Field of the Invention

The present invention relates to telephone communication and, more particularly, to a communication system and a communication service method through Internet call intermediation, in which servers call a calling party and a called party using a callback function when a telephone call is requested through the Internet, to allow the calling party and called party to communicate with each other, thereby enabling convenient communication between them with lower charges.

2. Background of the Related Art

A callback system is a method using the difference between international telephone charges of countries, in which, when a user residing in a country having expensive international telephone charges calls a callback business proprietor in a country having low international telephone charges and rings off, the proprietor tracks the telephone number of a called party and calls the called party to connect the calling party and the called party to each other. However, because this callback telephone system uses only general telephones, it is inconvenient for its user to use the system. Further it causes problems related with billing for the proprietor and restriction by governments.

In the utilization of domestic long distance telephone and international telephone services without using the callback function, a client who is given a personal identification number by a communication business proprietor must input the business access number of the proprietor, his personal identification number and a called party's telephone number through the telephone to use the telephone services. For this, the client should purchase an additional apparatus for inputting the access number, personal identification number and so forth.

### SUMMARY OF THE INVENTION

An object of the present invention is to provide a communication system and a communication service method through Internet call intermediation, in which servers call a calling party and a called party using the callback function when a telephone call is requested through the Internet, to allow the calling party and called party to communicate with each other, thereby enabling convenient communication between them with lower charges.

For the communication system and communication service method according to the present invention, various servers are grouped, a telephone call is requested through inter-operation of the grouped server and a calling party (client), and intermediation for voice communication between a calling party and a called party is carried out using the callback function. Further, the invention requires automatic telephone call connection, inquiry of details about a telephone call and billing of telephone charges, which are performed by a call intermediation server, and subscriber management by an Internet web server.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To accomplish the object of the invention, there is provided a communication system through Internet call intermediation, by which a calling party requests a telephone call through the call intermediation by using his computer capable of accessing the Internet, and the calling party's telephone and a called party's telephone, which are connected to a predetermined communication network, are connected to each other, the communication system comprising a web server, connected to the Internet, for performing a browsing function of an Internet site for the telephone call through call intermediation; a network server for managing smooth communication of the Internet; a billing server for confirming and calculating charges for the telephone call; a call intermediation server for intermediation between the calling party and the called party for the call connection between them at the request of the calling party; a DB server, connected to the servers, for constructing a database of overall information including the balance of the calling party and providing the information; and a gateway for enabling telephone communication between the calling party and the called party by connecting the calling party's telephone and the called party's telephone, which are connected to the predetermined communication network, to each other through the intermediation of the call intermediation server, wherein each of the servers are connected one another.

There is also provided a communication service method through Internet call intermediation, comprising a communication authentication step in which a calling party who wants to make a telephone call connects with an Internet site providing telephone communication service through the call intermediation, to judge if the telephone call is available or not; a communication request step in which the calling party confirmed to be an authenticated user inputs his telephone number and a called party's telephone number to request the telephone call; a speaker callback step for enabling the telephone call by callback-dialing the inputted telephone numbers of the calling party and the called party; a telephone call execution step in which the calling party communicates with the called party and charges for the telephone call are charged based on the period of time for which the telephone call is made; and a charge billing step for billing the charges for the telephone call upon the completion of the telephone call.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a diagram for explaining a communication system through Internet call intermediation according to an embodiment of the present invention;

FIGS. 2a and 2b are flow diagrams showing a communication service method through Internet call intermediation according to an embodiment of the present invention;

FIG. 3 illustrates a “making a phone call” page of an Internet site according to an embodiment of the present invention; and

FIG. 4 illustrates a list of details about telephone calls.

### DETAILED DESCRIPTION OF THE INVENTION

Reference will now be made in detail to the preferred embodiments of the present invention, examples of which are illustrated in the accompanying drawings.

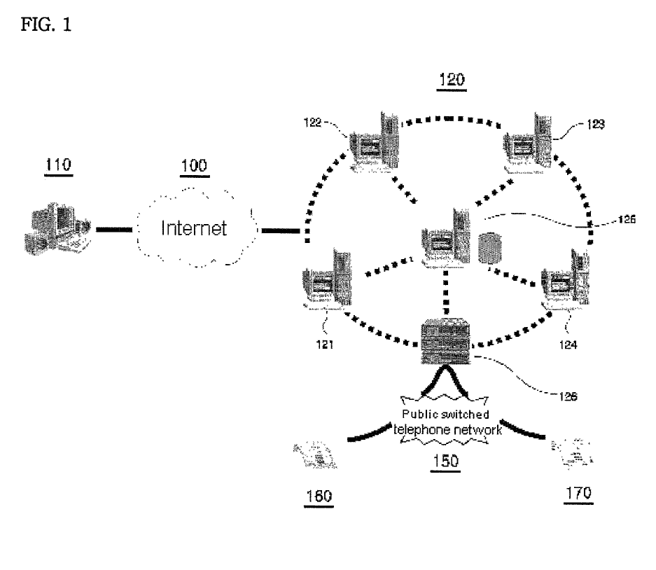

FIG. 1 is a diagram for explaining a communication system through Internet call intermediation according to an embodiment of the present invention. Referring to FIG. 1, the communication system of the present invention is constructed in a manner that a calling party's computer 110 and a server group 120 are connected to each other via the Internet 100 that is an information network, and a calling party's telephone 160 and a called party's telephone 170, which are connected to a public switched telephone network 150, can communicate with each other under the control of the server group 120. The server group 120 includes a web server 121, a network management server 122, a billing server 123, a call intermediation server 124, a DB server 125, and a gateway 126.

The web server 121 of the server group 120 connected to the Internet performs a variety of browsing functions, such as management of subscribers, management of information about calling parties, serving as a called party telephone directory, giving personal identification numbers to subscribers and identification of the subscribers, electronic commerce, inquiry of details about telephone calls, inquiry of the balance, and so on. The network management server 122 allows communication using the Internet to be smoothly carried out. The billing server 123 performs confirmation and calculation for charges for telephone calls, such as confirmation of the balance, initiation of billing according to call connection, final billing and balance confirmation after completion of a telephone call.

The call intermediation server 124 connects a calling party and a called party to each other, makes charges for telephone calls, provides information on details about telephone calls, confirms the balance and, in case of insufficient balance with respect to the personal identification number of a subscriber who pays in advance, carries out automatic recharging through a credit card the subscriber registers. The DB server 125 constitutes a database of information related with information movement state, signing-in state, and the balances of users of each server constructing the server group 120. The gateway 126 executes VoIP (Voice over Internet Protocol), that is, compresses a voice signal and transmits it as data through a packet-based network using an IP. These IP and Internet telephone techniques have advantages that users can be provided with international telephone service in Internet and Intranet environments with charges lower than conventional international telephone service charges because they provide telephone services by employing existing IP networks without any change.

The detailed operations of the servers 121 to 125 and the gateway 126 constructing the server group 120 will be explained below.

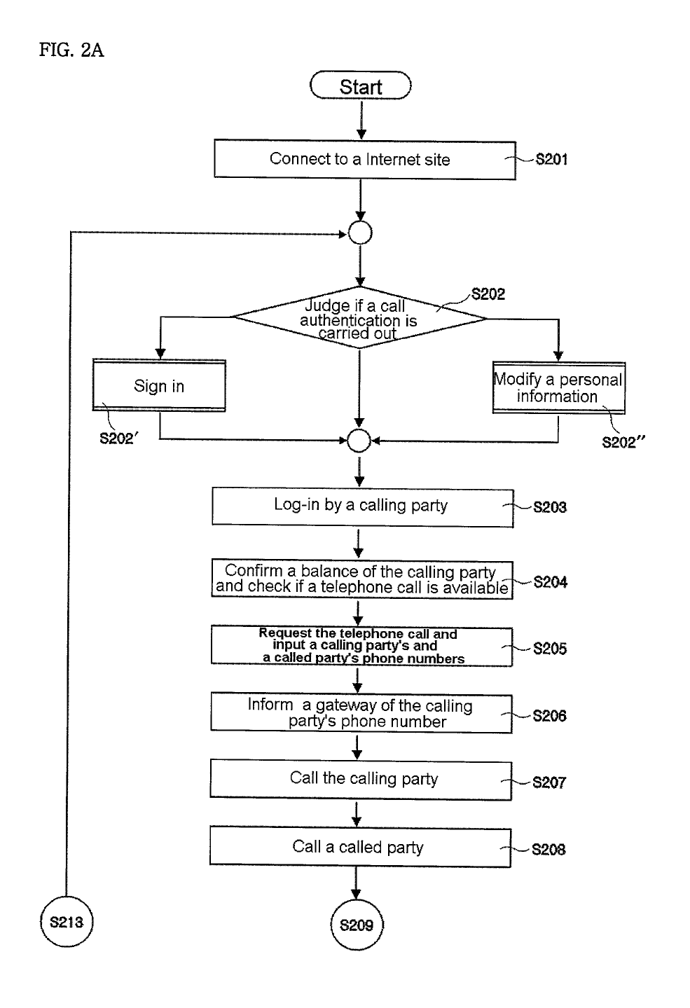

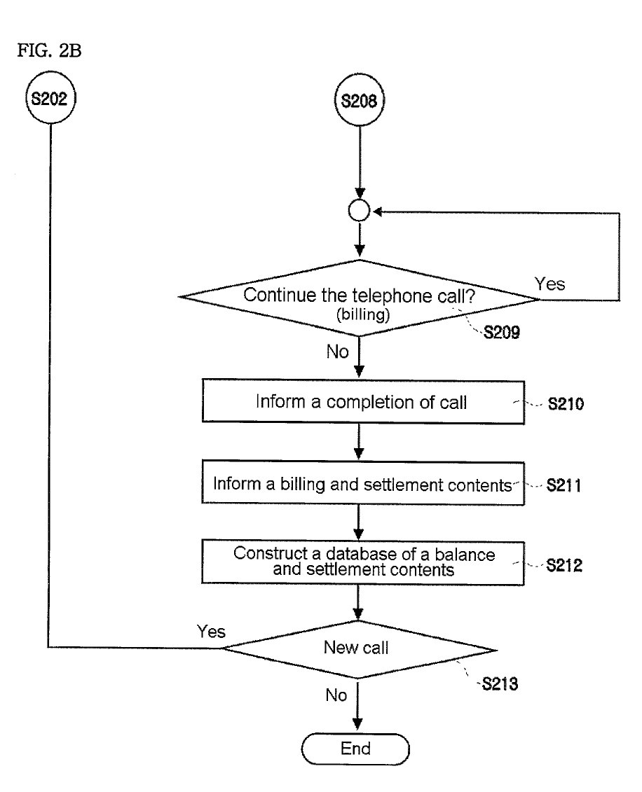

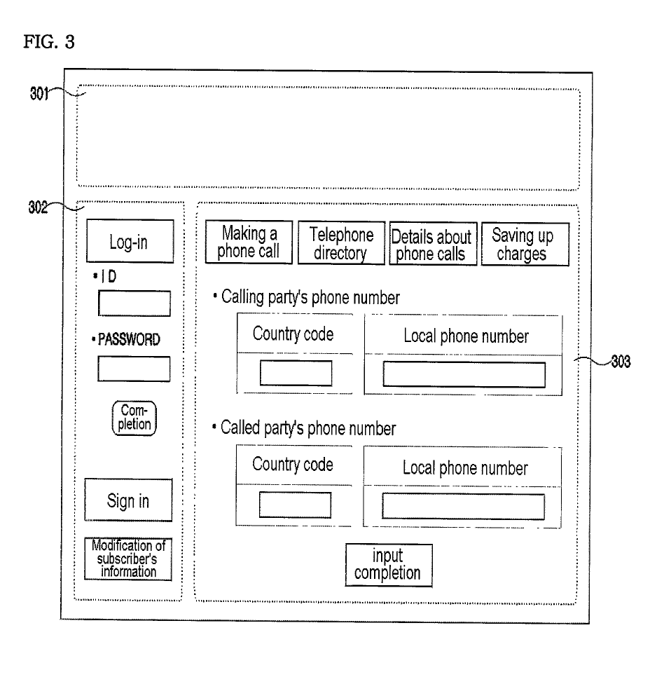

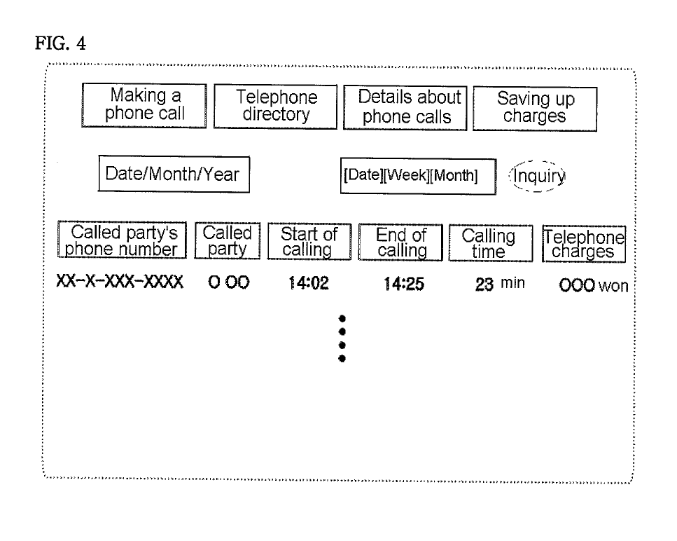

FIGS. 2a and 2b are flow diagrams showing a communication service method through Internet call intermediation according to a preferred embodiment of the present invention. FIG. 3 illustrates a “making a phone call” page of an Internet site executed in this embodiment, and FIG. 4 illustrates a list of details about telephone calls.

The communication service method through Internet call intermediation according to the present invention is roughly divided into a communication authentication step, a communication request step, a speaker callback step, a telephone call execution step, and a charge billing step.

In the communication authentication step, a calling party who wants to make a telephone call accesses an Internet site providing telephone call services through call intermediation and judges if the telephone call is available or not. In addition, signing-in and user information modification with respect to authentication of telephone communication are performed in this step. Specifically, the calling party who wants to make a call first accesses an Internet site (S201) according to an embodiment of the invention. The Internet site can be designed such that it has various forms and functions according to the intention of a designer. This Internet site is explained in this specification in consideration of telephone communication through call intermediation.

As shown in FIG. 3, the “making a phone call” page of the Internet site according to the embodiment of the invention is roughly divided into a top frame 301, a menu frame 302, and a contents frame 303. This web page is designed according to the intention of a home page designer and it can be varied.

In the top frame 301, the logo of a company or advertisements can be placed. If required, sub-menus for navigation of home pages can be located in this frame. The menu frame 302 is provided with menus of log-in, sign-in, modification of subscriber's information, and the like. A subscriber (calling party) who wants to use communication service of the invention inputs his ID and password using the log-in menu and clicks “completion” to request authentication for using telephone call service.

Then, the web server 121 judges whether the calling party is authenticated or not (S202). Here, the calling party signs in when he has not been signed in yet (S202′), and modifies his personal information when he wants to (S202″). In this procedure, the information about the calling party or modified contents is transmitted to the DB server 125 of the server group 120.

After connection with the Internet site, the calling party judges whether he signs in or modifies his personal information (S202). Upon completion of signing-in or personal information modification, the calling party inputs his ID and password to perform log-in (S203).

The contents inputted by the calling party are transmitted to the web server 121, and the web server 121 delivers the inputted contents to the billing server 123. The billing server 123 confirms the balance of the calling party to check if telephone call is available and informs the web server 121 of the checked result. In addition, it informs the network management server 122 and call intermediation server 124 of related contents, to allow the calling party to make a call. By doing so, the communication authentication procedure is finished (S204). This authentication procedure can be carried out in such a manner that a personal identification number is given to a subscriber, a telephone-charge-prepaid card is issued to the subscriber, and the subscriber is identified by confirming his personal identification number.

As shown in FIG. 3, the contents frame 303 of the “making a phone call” page is provided with menus “making a call”, “telephone directory”, “details about phone calls”, “saving up phone charges”, and the like at the upper part thereof. These menus can be changed or further include additional menus if required.

Since the communication system of the present invention performs telephone communication according to the callback function, the contents frame 303 is further provided with input spaces in which a calling party's telephone number and a called party's telephone number are inputted. The calling party inputs his phone number and a called party's phone number and clicks “Completion”, or selects the called party's number from a list of telephone directory stored in advance in the DB server in order to attempt to make a call through call intermediation. In the present invention, the calling party and the called party who live in the same country can communicate with each other. In this case, if their country is set as the initial country, the users can use the service more conveniently without inputting a country code.

After the communication authentication step, the communication request step is carried out, in which the calling party authenticated inputs his telephone number and a called party's telephone number to request telephone call. Specifically, the calling party inputs his phone number and the called party's phone number in the corresponding spaces of the contents frame 303 shown in FIG. 3, and then clicks “Input completion”. Then, the inputted phone numbers are stored in the DB server 125 through the web server 121.

Subsequently, the speaker callback step is performed, which callback-dials the inputted phone numbers of the calling party and the called party to allow them to be able to communication with each other. In this procedure, the call intermediation server 124 informed of the request of the calling party for telephone call reports the gateway 126 of the calling party's telephone number. The gateway 126 calls the calling party by the informed phone number (S207) and, after the lapse of a predetermined waiting time, calls the called party upon reception of a response signal from the calling party's telephone 160 (S208).

The speaker callback step is followed by the telephone call execution step in which the gateway 126 connects voice signals of the calling party and the called party to each other to enable telephone communication between them, and continuously checks if the communication continues. In this step, the gateway 126 sends a communication connection signal to the call intermediation server 124, and the call intermediation server 124 informs the billing server 123 of it so as to allow the billing server to execute billing procedure until the communication is finished (S209).

Upon completion of communication between the calling party and the called party, the telephone charge billing step is carried out. Specifically, when the telephone call has been finished, the gateway 126 sends a call completion signal to the billing server 123 and the call intermediation server 124 (S210). The billing server transmits billing contents to the web server 121, reduces the billed charges from the balance of the calling party, stored in the DB server 125, and then informs the calling party of the billing contents and settlement contents (S211). The calling party confirms the informed balance and settlement contents and transmits it to the web server 121. The web server 121 reports the DB server of the settlement contents and finishes the charge billing procedure (S212).

Thereafter, the server group 120 inquires of the calling party that he wants to make another call. If the calling party does, the procedure returns to the step S202 in which it is judged if authentication for telephone call is carried out or not. If he does not, the procedure is completed (S213).

FIG. 4 is a diagram for explaining the list of details about telephone calls, that is one of various sub-menus according to the embodiment of the invention.

As shown in FIG. 4, when the calling party accesses the Internet to execute the “details about phone calls” among the menus of the contents frame 303, the details with respect to the corresponding date (week, month, and the like), stored in the DB server 125, are displayed in detail. The display form of these details can be selected according to the taste of the calling party (user) who connects with the corresponding Internet site. In addition, more detailed items with respect to related contents can be selectively displayed. Further, the present invention can display various menus such as telephone directory, saving of communication service charges, an the like in addition to the aforementioned details according to a database of contents related with the designing of an Internet home page registered to the server group 120.

Moreover, a credit card, charge charging by payment of cash, electronic money and the like can be used in the present invention. The telephone network through which a calling party and a called party are connected to each other may include a general telephone network and Internet.

Various modifications may be made without departing from the spirit and scope of the present invention. For example, the Internet site according to the invention can be designed in various ways and accordingly the database can be modified. Further, more convenient charge payment means can be employed.

According to the present invention, domestic and international telephone communication between a calling party and a called party can be carried out with lower telephone service charges by using the callback function. Furthermore, the invention allows a callback communication business proprietor or a communication business proprietor to be able to provide high-quality economical call intermediation service.

What is claimed is:

1. A communication system through Internet call intermediation, by which a calling party requests a telephone call through the call intermediation by using his computer capable of accessing the Internet, and the calling party's telephone and a called party's telephone, which are connected to a predetermined communication network, are connected to each other, the communication system comprising:
a web server, connected to the Internet, for performing a browsing function of an Internet site for the telephone call through call intermediation;
a network server for managing smooth communication of the Internet;
a billing server for confirming and calculating charges for the telephone call;
a call intermediation server for intermediation between the calling party and the called party for the call connection between them at the request of the calling party;
a DB server, connected to the servers, for constructing a database of overall information including the balance of the calling party and providing the information; and
a gateway for enabling telephone communication between the calling party and the called party by connecting the calling party's telephone and the called party's telephone, which are connected to the predetermined communication network, to each other through the intermediation of the call intermediation server,
wherein each of the servers are connected one another.

2. The communication system according to claim 1, wherein a general telephone network is used as the predetermined communication network.

3. The communication system according to claim 1, wherein the Internet is used as the predetermined communication network.

4. The communication system according to claim 1, wherein the gateway performs VoIP (Voice over Internet Protocol) function.

5. The communication system according to claim 1, wherein the database of the DB server contains a personal telephone directory inputted therein by a user in advance.

6. A communication service method through Internet call intermediation, comprising:
a communication authentication step in which a calling party who wants to make a telephone call connects with an Internet site providing telephone communication service through the call intermediation, to judge if the telephone call is available or not;
a communication request step in which the calling party confirmed to be an authenticated user inputs his telephone number and a called party's telephone number to request the telephone call;
a speaker callback step for enabling the telephone call by callback-dialing the inputted telephone numbers of the calling party and the called party;
a telephone call execution step in which the calling party communicates with the called party and charges for the telephone call are charged based on the period of time for which the telephone call is made; and
a charge billing step for billing the charges for the telephone call upon the completion of the telephone call.

7. The communication service method according to claim 6, wherein, in the communication authentication step, a personal identification number is given to a user who uses the communication service and, when the calling party is authenticated, his personal identification number is confirmed.

8. The communication service method according to claim 6, wherein, in the communication request step, the called party's telephone number is selected from a list of personal telephone directory stored in advance, to request the telephone call.
